(19) United States
(12) Patent Application Publication
(10) Pub. No.: US 2010/0313780 A1
(43) Pub. Date: Dec. 16, 2010

(54) REGISTER CONTROL METHOD AND PRINTING PRESS

(75) Inventors: Minoru Sato, Hiroshima (JP); Takanori Iwai, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/446,354

(22) PCT Filed: Oct. 24, 2007
(86) PCT No.: PCT/JP2007/070737

§ 371 Date: Apr. 20, 2009

(30) Foreign Application Priority Data
Oct. 25, 2006 (JP) 2006-290443

(51) Int. Cl. B41F 1/34

(52) U.S. Cl. 101/481; 101/485

(57) ABSTRACT

A register control method and printing press capable of preventing wasted paper and improving cost effectiveness by improving detection of a register mark is provided. A position of a register mark printed on a web before starting printing is predicted. A plate cylinder is preset on the basis of the prediction. Then, a predicted value of the register mark position to be used for the next operation is corrected on the basis of the difference between the position of an actual printed register mark and the predicted position. For example, when the predicted value of the register mark is A, an actual position of a register mark is B, and the corrected predicted value of the register mark is A′, correction is carried out on the basis of A′=A+(B−A)×k (where k is a coefficient smaller than one).

### TECHNICAL FIELD

The present invention relates to a register control method of carrying out register control for each color when performing multicolor printing and to a printing press that is capable of employing this method.

### BACKGROUND ART

Typically, a printing press capable of multicolor printing is configured of reel stand units for supplying webs; in-feed devices for applying appropriate tension to the webs; printing units; a web conveying device for conveying the webs, after printing, to a folding unit, splicing the webs, and carrying out printing alignment in the flow direction; and the folding unit for cutting and folding the webs into quires and conveying the quires.

With a printing press capable of multicolor printing according to the related art, after tension applied to the paper fed out from paper rolls is adjusted at the in-feed devices, printing is carried out at the printing units. The printing units are provided in correspondence to, for example, the four colors black, cyan, magenta, and yellow, enabling multicolor printing by overlapping these colors on the same sheet of paper. Then, after printing, the paper is passed through the web conveying device and is cut (and folded in some cases) at the folding unit before being conveyed outside the printing press.

As described above, since the printing units print each of the four colors of ink, black, cyan, magenta, and yellow, on the same area on the paper in an overlapping manner, it is important for printing quality to precisely align the printing position of each color. In general, such “printing alignment” is called “register control”.

Therefore, when carrying out multicolor printing, together with the actual image, special marks for measuring misregister (hereinafter referred to as “register marks”) are printed on the paper. The register marks on the paper after printing are captured with a camera. In the past, when there was deviation from the predetermined positions, the register control device of the printing press was operated to perform register. At the beginning of printing, automatic control starts after the printing speed reaches a speed at which the register marks on the paper are stably printed (for example, 36,000 copies per hour).

Patent Document 1:

Japanese Unexamined Patent Application, Publication No. HEI-10-278235

### DISCLOSURE OF INVENTION

However, when printing gradually starts from a state in which nothing is printed on the paper or when the register marks are printed outside the view of a camera, such as at the beginning of printing, there is a problems in that the time required for detecting the marks becomes long, and thus the amount of wasted paper increases due to misregister.

For example, when a mark is not detected within the camera view, the plate cylinder is moved in the top-to-bottom (or left-to-right) direction. However, if the mark exist in a direction opposite to the moving direction, even more time will be required. Furthermore, when starting printing after an emergency stop at high speed (for example, 150,000 copies per hour), the register positions may not be suitable for the color matching speed because the register positions are suitably set for high speed.

The present invention has been conceived in light of the circumstances described above, and an object thereof is to provide a register control method and a printing press capable of preventing wasted paper and improving by improving the detection accuracy of a register mark.

To achieve the above-described object, a first aspect of the present invention provides a register control method for a printing press including a plurality of printing units having plate cylinders for printing on webs, the printing units printing register marks on the webs, the printing press carrying out register control on the basis of detected positions of the register marks, the method including predicting a position of a register mark printed on the web before starting printing; presetting the plate cylinder on the basis of the prediction; and correcting a predicted value of the register mark position to be used for the next operation on the basis of the difference between the position of an actual printed register mark and the predicted position.

A second aspect of the present invention provides a printing press for printing on a web, including a plurality of printing units that have plate cylinders for printing on the webs and that print register marks on the webs; a controller that predicts the position of the register mark printed on the web and that presets the plate cylinder on the basis of the prediction; and a sensor that detects the position of the register mark, wherein the controller corrects the predicted value of the register mark position to be used for the next operation on the basis of the difference between the position of an actual printed register mark and the predicted position.

In the first and second aspects, since the predicted value of the register mark position is corrected on the basis of the difference between the actual register mark position and the predicted position, the register mark can be detected in a short amount of time during the next operation. Thus, the amount of wasted paper produced until register control is completed can be reduced.

In the first aspect, when the plate cylinder is preset on the basis of the predicted value of the register mark position, the predicted value of the register mark position used for the next operation may be corrected so that the register mark is positioned within a detection range of a sensor that detects the register mark.

In the second aspect, when the plate cylinder is preset on the basis of the predicted value of the register mark position, the controller may correct the predicted value of the register mark position used for the next operation so that the register mark is positioned within a detection range of the sensor.

In this way, since the predicted value is corrected so that the register mark printed during the next operation is positioned within a detection range of a sensor (for example, camera) on the basis of the difference between the actual printed register mark position and its predicted value, the register mark can be detected quickly by the sensor during the next operation.

In the first aspect, when the predicted value of the register mark is A, an actual position of a register mark is B, and the corrected predicted value of the register mark is A′, correction may be carried out on the basis of:

A′=A+(B−A)×k

where k is a coefficient smaller than one.

In the second aspect, when the predicted value of the register mark is A, an actual position of register mark is B, and the corrected predicted value of the register mark is A′, the controller may carry out correction on the basis of:

A′=A+(B−A)×k

where k is a coefficient smaller than one.

In this way, the predicted value of the register mark position is corrected on the basis of a value acquired by multiplying the difference of the actual register mark position and its predicted value by a coefficient k. For example, when the change in the operating condition is large, such as immediately after changing the paper, a large value is selected as k. In this way, correction can be performed by considering the misalignment of the actual register mark with respect to the predicted value of the register mark to be large. Normally, the average is, for example, approximately 0.5, and even when the difference between B and A is large, the difference is considered to be temporary, and the weighting of the register value B is made small. The coefficient k may be changed depending on the image ratio, the type of paper, and the manufacturer. In other words, a table may be prepared in advance, and the value k may be determined by reading it out from the table on the basis of the operating condition. The table can be changed as needed.

According to the present invention, when a plate cylinder is preset on the basis of a predicted register mark position, the probability of a detection mark being within the sensor view can be increased. As a result, the amount of wasted paper produced until register control is completed can be reduced. The effect of time reduction is great with a multi-page printing rotary press for newspaper having many variable factors, and cost losses can be significantly reduced.

### BRIEF DESCRIPTION OF DRAWINGS

FIG. 1 is a schematic view illustrating, in outline, the structure of a web offset press according to an embodiment of the present invention.

FIG. 2 illustrates the operating speed of the web offset press according to an embodiment of the present invention.

FIG. 3 is a schematic plan view of a view of a camera included in the web offset press according to an embodiment of the present invention and detection marks.

### EXPLANATION OF REFERENCE SIGNS

3: printing unit
9: web offset press control unit (controller)
25: plate cylinder
31: potentiometer
32: camera
100: camera view

### BEST MODE FOR CARRYING OUT THE INVENTION

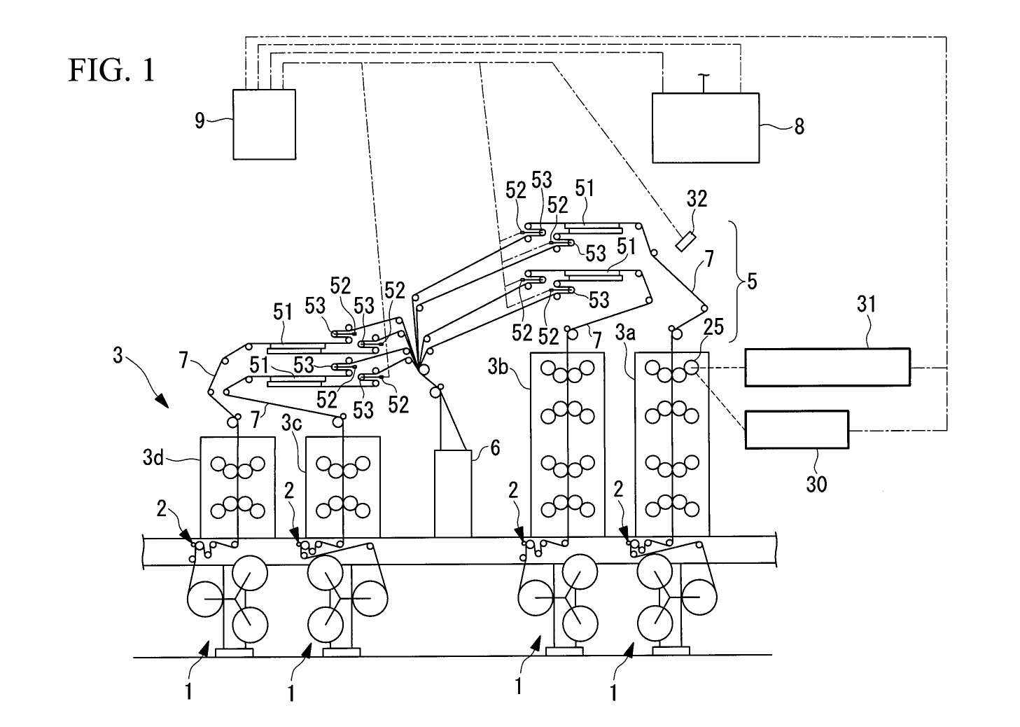

An embodiment of the present invention will be described below with reference to the drawings. This embodiment is an application of the present invention to a offset newspaper rotary press for multi-page duplex printing. FIG. 1 is a schematic view illustrating, in outline, the entire offset newspaper rotary press with a multi-page duplex printing/multi-color printing unit. The offset newspaper rotary press includes a plurality of reel stand units 1 for supplying webs 7; in-feed devices 2 for applying appropriate tension to the webs 7; printing units 3; a web conveying device 5 for conveying the webs 7, after printing, to a folding unit 6, splicing the webs 7, and carrying out printing alignment in the flow direction; the folding unit 6 for cutting and folding the webs 7 into quires and conveying the quires; and a web offset press control unit (controller) 9 for controlling the entire web offset press.

The reel stand unit 1 is configured to hold three paper rolls constituting the webs 7 wound into rolls. When paper is fed from a first paper roll, a second paper roll is in a paper-splicing preparation state, and a third paper roll is loaded. When the remaining amount of the web 7 on the first paper roll decreases, the web 7 on the second paper roll is spliced. While the web 7 is supplied from the second paper roll, the first paper roll is loaded and prepared for paper splicing. In this way, the web 7 is continuously fed from the reel stand unit 1 to the printing unit 3.

The number of units included in the printing units 3 corresponds to the number of printing colors. In this embodiment, printing units 3a to 3d are provided as the printing units 3. The printing units 3a and 3b are each provided with four printing units on both sides of the web for printing black, cyan, magenta, and yellow, in this order from the bottom. These colors are mixed to perform color printing. Similarly, the printing units 3c and 3d are each provided with two printing units for printing black and one other color.

Describing in outline the structure of the printing unit 3a as a representative example, printing of the four colors black, cyan, magenta, and yellow is performed on the web 7 by the printing units. Printing on the web 7 means printing in the same area on the web 7 that is continuously flowing. In this way, the colors overlap in the same area to form one image, enabling multicolor printing of the image. Together with the actual image, special marks for register control of the colors (hereinafter referred to as “register marks”) are printed on the web 7 to measure misregister. The register marks are captured by a camera (sensor) 32, and then the image information is processed by the web offset press control unit 9. The camera 32 is provided for each printing unit 3. In the drawing, however, only the one associated with the printing unit 3a is illustrated. Each of the printing units constituting the printing unit 3a includes devices functioning as various rollers, such as an ink roller and a plate cylinder 25. Motive energy from a common motor is supplied to these various devices.

A driving device 30 for performing register control of the plate cylinder 25 is provided independently for each color. The plate cylinder 25 is provided with a potentiometer 31 for detecting the register position of the plate cylinder 25. In FIG. 1, the potentiometer 31 is provided for only one color, but a potentiometer 31 is provided for each plate cylinder 25 corresponding to each color. Since the bottom printing unit for black serves as a reference for register control, in some cases, it may not be provided with the driving device 30 for performing register control of the plate cylinder 25 and the potentiometer 31.

Plate-cylinder-position detecting means used for detecting the position of the plate cylinder 25 is not limited to the potentiometer 31.

The printing units 3b to 3d have the same structure, and thus descriptions will not be repeated. These printing units are merely examples, and appropriate printing units, such as single-color printing units for carrying out duplex monochrome printing or printing units for carrying out four-color printing on one side and two-color printing on the other side, may be employed.

The printing units 3 carry out predetermined printing on the webs 7 supplied from the reel stand units 1 and supply the webs 7 to the web conveying device 5. The web conveying device 5 includes many turn bars 51 and is configured to change the running routes of the webs 7 from the printing units 3 such that the stacking order can be changed. The width of the webs 7 is equal to the width of four pages of a regular newspaper. The webs 7 illustrated in the drawing are cut with a slitter at the center in the width direction after printing. Then the two-page-wide web 7 on one side in the width direction is overlapped on the two-page-wide web 7 on the other side. In this way, the web 7 entering the folding unit has eight sheets, and 32-page printed material, i.e., eight layers of newspaper each having four pages (two pages on each side) is ejected to one side of the folding unit 6.

The folding unit 6 is configured to stack the plurality of webs 7 sent from the web conveying device 5 and eject desired folded sections by longitudinal cutting, longitudinal folding using a triangular plate, lateral cutting, and/or lateral folding.

When the webs 7 are directly guided into the folding unit 6, without cutting with a slitter at the center in the width direction after printing and stacking them one on the other, 16-page newspapers can be ejected to both sides. There is a device for switching and delivering the webs, after printing at the printing units 3a and 3b capable of color printing, to any position. This device, however, is not illustrated. To increase the number of pages, another web 7 is introduced from an adjacent printing unit. When the number of pages is small, e.g., when three of the printing units 3 are used, the path to the folding unit 6 of a web 7 printed at a printing unit 3 differs depending on which three printing units 3 are selected.

In this way, the lengths of the webs 7 from the printing units 3 to the folding unit 6 may vary depending on the operating pattern. In other words, the web offset press according to this embodiment includes compensator rollers 53 for performing position control since the cutting position of the folding unit 6 with respect to the printing position changes. Each compensator roller 53 is equipped with moving means 52 for moving it, supporting means, and a position detecting device, such as a potentiometer. In addition, a compensator control device 8 for controlling the positions of the compensator rollers 53 is provided.

Next, the operation of the web offset press will be described. The following operation is controlled by the web offset press control unit 9.

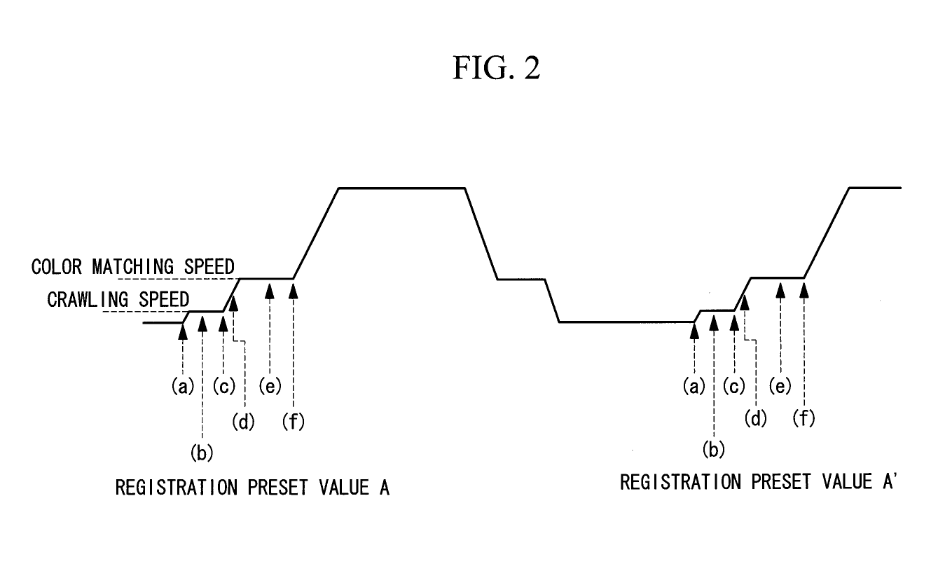

FIG. 2 illustrates the printing speed of the web offset press. First, a crawling operation is carried out (a). The web offset press control unit 9 presets the plate cylinders 25 of the printing units corresponding to the colors of the printing units 3a to 3d at positions corresponding to a register preset value A (b). More specifically, the register preset value A is stored in advance in the web offset press control unit 9, and, by controlling the driving device 30 with the web offset press control unit 9 and by detecting the positions of the plate cylinders 25 with the potentiometer 31, the top-to-bottom and right-to-left directions of the plate cylinders 25 are adjusted (preset) to correspond to the register preset value A.

Next, the rotational speed is increased to start printing (c), and an automatic register operation is started when the speed reaches a speed at which the register marks on the paper are stably printed (d). During automatic register operation, the register mark of each color printed on the paper is recognized and image-processed by the camera 32, and the plate cylinders 25 are aligned. The alignment of the plate cylinders 25 is carried out by controlling the driving device 30 with the web offset press control unit 9. For example, the black register mark positioned furthest upstream is set as a reference, and the cyan, magenta, and yellow register marks are aligned correctly with respect to the black register mark.

Usually, the automatic register process is completed within a predetermined amount of time from the beginning of the automatic register operation (surface regulation completed), and acceleration of the plate cylinders 25 begins (f) after a predetermined amount of time from the moment satisfactory paper is obtained (e). At this time, plate-cylinder register positions (register value B) of the units corresponding to the colors of the printing units 3a to 3d are taken in through the potentiometer 31 and stored in the web offset press control unit 9.

When the register marks are not within the view of the camera 32, the amount of wasted paper increases due to register failure. In this embodiment, by repeating the operation, the original register preset value A is corrected so that the probability of the register marks being positioned outside the camera view decreases.

After the predetermined operation is completed, the register preset value A is corrected before the next operation on the basis of the acquired register value B. The corrected value is a register preset value A′. More specifically, the web offset press control unit 9 performs correction with a value acquired by multiplying the difference between the register value B and the register preset value A by a coefficient, as represented by the equation below. In other words, the correction of the register preset value A is weighted by coefficient k.

A′=A+(B−A)×k

For example, after the paper roll is changed, k is set to a large value for the next one or several operations to increase the correction weight of the register preset value A by the register value B. Normally, the average is, for example, approximately 0.5. In other words, even when the difference between B and A is large, the difference is considered to be temporary, and the weighting of the register value B is made small. The coefficient k is selected by the web offset press control unit 9 on the basis of the operating state.

The coefficient k may be changed depending on the image ratio, the type of paper, and the manufacturer. In other words, a table associated with these conditions is prepared in advance and stored in the web offset press control unit 9. The web offset press control unit 9 determines k on the basis of this table. The table can be changed as needed. The web offset press control unit 9 selects k from the table on the basis of the operating condition. For example, when the image ratio is large, the paper becomes moist, and thus stretching of the paper is large. Thus, the web offset press control unit 9 changes the setting of k in response to the image ratio. The initial value of the register preset value A may be selected by the web offset press control unit 9 from the table stored in advance on the basis of the operating condition, such as the type of paper, etc.

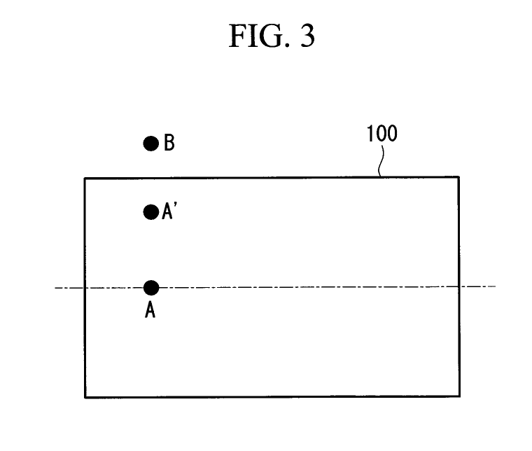

Reference numeral 100 in FIG. 3 represents a camera view of the camera 32. The plate cylinder 25 is registered (preset) according to the register preset value A in the above-described (b) since the register mark is presumed to be located within the camera view. However, in particular, the register mark may be located outside the camera view 100 (position B) immediately after the paper roll is changed. In such a case, recognition of the register mark by the camera may take time, and the amount of wasted paper increases due to register failure.

The register preset value is corrected as described above on the basis of the difference between A and B, and the plate cylinder 25 is registered according to the corrected register preset value A′ for the next operation (b). In this way, the probability of the register mark being within the camera view 100 when the automatic register operation is started can be increased. When the operating condition changes, such as when the paper roll is changed as described above, appropriate correction corresponding to the situation can be carried out by increasing the corrected register preset value A′ so that it approaches the register value B.

According to the above-described embodiment, the probability of a detection mark according to the register preset value A being within the camera view can be increased. As a result, the amount of wasted paper produced until register control is completed can be reduced. In particular, the effect of time reduction is great with a multi-page printing rotary press for newspaper having many variable factors, and cost losses can be significantly reduced.

1. A register control method for a printing press including a plurality of printing units having plate cylinders for printing on webs, the printing units printing register marks on the webs, the printing press carrying out register control on the basis of detected positions of the register marks, the method comprising:
predicting a position of a register mark to be printed on the web before starting printing;
presetting the plate cylinder on the basis of the prediction; and
correcting a predicted value of the register mark position to be used for the next operation on the basis of the difference between the position of an actual printed register mark and the predicted position.

2. The register control method according to claim 1, wherein, when the plate cylinder is preset on the basis of the predicted value of the register mark position, the predicted value of the register mark position used for the next operation is corrected so that the register mark is positioned within a detection range of a sensor that detects the register mark.

3. The register control method according to claim 1, wherein, when the predicted value of the register mark is A, an actual position of a register mark is B, and the corrected predicted value of the register mark is A′, correction is carried out on the basis of:
A′=A+(B−A)k
where k is a coefficient smaller than one.

4. A printing press for printing on webs, comprising:
a plurality of printing units that have plate cylinders for printing on the webs and that print register marks on the webs;
a controller that predicts the position of the register mark printed on the web and that presets the plate cylinder on the basis of the prediction; and
a sensor that detects the position of the register mark,
wherein the controller corrects the predicted value of the register mark position to be used for the next operation on the basis of the difference between the position of an actual printed register mark and the predicted position.

5. The printing press according to claim 4, wherein, when the plate cylinder is preset on the basis of the predicted value of the register mark position, the controller corrects the predicted value of the register mark position used for the next operation so that the register mark is positioned within a detection range of the sensor.

6. The printing press according to claim 4, wherein, when the predicted value of the register mark is A, an actual position of register mark is B, and the corrected predicted value of the register mark is A′, the controller carries out correction on the basis of:
A′=A+(B−A)×k
where k is a coefficient smaller than one.
